(19) United States
(12) Patent Application Publication
(10) Pub. No.: US 2025/0312704 A1
(43) Pub. Date: Oct. 9, 2025

(54) Telescopic Suction Cup Robot Toy

(71) Applicant: Ayhan Ozcan, Hackensack, NJ (US)

(72) Inventor: Ayhan Ozcan, Hackensack, NJ (US)

(21) Appl. No.: 18/626,152

(22) Filed: Apr. 3, 2024

(51) Int. Cl. A63H 3/04; F16B 47/00

(52) U.S. Cl. CPC A63H 3/04; F16B 47/00

(57) ABSTRACT

The present invention relates to a suction fidget tube, specifically designed to provide entertainment and engagement for children during travel, as well as in various settings such as church, school, or home. Each package contains 4 individually wrapped Telescopic Suction Cup Robot Toy travel toy characters in vibrant opaque colors, meticulously crafted to provide a strong and safe experience. The Telescopic Suction Cup Robot Toy is ideal for igniting imaginations, promoting creativity, and offering relief for those with attention deficits, making it a versatile and essential accessory for children of all ages.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to fidget toy and more particularly relates to the Telescopic Suction Cup Robot Toy, specifically designed to provide entertainment and engagement for children during travel, as well as in various settings such as church, school, or home

### Description of the Related Art

Traveling with children often poses challenges, particularly in keeping them engaged and content during long journeys. Portable entertainment solutions, such as travel toys, have become indispensable for caregivers seeking to alleviate boredom and restlessness in young travelers. Among these, fidget travel toys have gained prominence for their versatility and ability to foster creativity and cognitive development in children.

The significance of travel toys, including suction fidget tubes variants, lies in their capacity to enhance the travel experience for families. By providing children with engaging activities, these toys help minimize disruptions and promote positive behavior during journeys. Moreover, they contribute to the cognitive growth of young minds by stimulating imagination, problem-solving skills, and sensory exploration.

Travel toys have a rich history dating back decades, evolving alongside changing travel trends and technological advancements. Traditional travel toys, such as coloring books and puzzles, have gradually given way to more interactive options like suction fidget tubes toys. These toys feature suction fidget tubes components that enable children to create, manipulate, and explore, making them ideal companions for travel adventures.

Market research indicates a steady rise in the global demand for travel toys, reflecting the growing recognition of their importance in family travel. Suction fidget tubes travel toys, in particular, have witnessed a surge in popularity due to their engaging nature and educational benefits. With a diverse array of options available, suction fidget tubes travel toys cater to various age groups and interests, contributing to their widespread appeal among families.

Recent innovations in travel toy technology have propelled the evolution of suction fidget tubes travel toys to new heights. Advancements in suction strength, durability, and safety features have enhanced the quality and longevity of these toys. Furthermore, manufacturers have introduced captivating themes, characters, and interactive elements, enriching the play experience for children. Additionally, there has been a focus on developing lighter, more compact, and environmentally sustainable travel toy options, aligning with modern families' preferences for convenience and eco-consciousness.

Multiple solutions have been presented in prior art. As a result of intensive studies on the requirements, the present inventor aims to provide a novel design of a suction fidget tubes travel toy consists of 4 Telescopic Suction Cup Robot Toy kids' travel toy characters, each individually wrapped for convenience and portability. These characters are carefully designed with strong and safe magnets, ensuring a secure and enjoyable play experience for children. The vibrant opaque colors of the characters enhance their appeal and captivate the attention of young users.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a compact and portable entertainment solution for children during travel, ensuring they remain engaged and content throughout the journey.

It is the objective of the invention to offer versatile play options, allowing children to create and explore imaginative scenarios with suction fidget tubes travel toy characters.

It is the objective of the invention to promote cognitive development by stimulating creativity, problem-solving skills, and sensory exploration in young minds.

It is the objective of the invention to alleviate boredom and restlessness in children during long car rides, plane trips, or other travel scenarios.

It is the objective of the invention to enhance the travel experience for families by providing a convenient and entertaining activity for children.

It is the objective of the invention to foster positive behavior in children during travel, reducing disruptions and promoting harmony among family members.

It is the objective of the invention to offer relief for individuals with attention deficits, such as those with anxiety or ADHD, by providing a calming and engaging activity.

It is the objective of the invention to contribute to the overall well-being of children by offering a fun and educational play experience.

It is the objective of the invention to provide families with a cost-effective and reusable entertainment option for multiple journeys.

It is the objective of the invention to support parents and caregivers by offering a reliable and convenient solution for keeping children entertained and engaged during travel.

Thus, it is the objective to provide an advancement in travel toys. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is view of three Suction fidget tubes incorporating the embodiments of the invention.

FIG. 2 shows a view of two Suction fidget tubes incorporating the embodiments of the invention.

FIG. 3 shows another view of four Suction fidget tubes as per preferred embodiments of the invention.

FIG. 4 shows another view of two Suction fidget tubes as per preferred embodiments of the invention.

FIG. 5 shows another view of four Suction fidget tubes as per preferred embodiments of the invention.

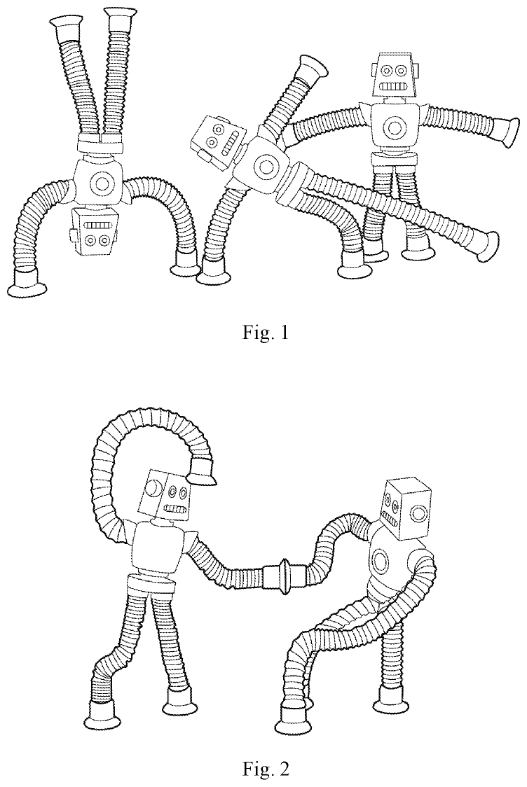

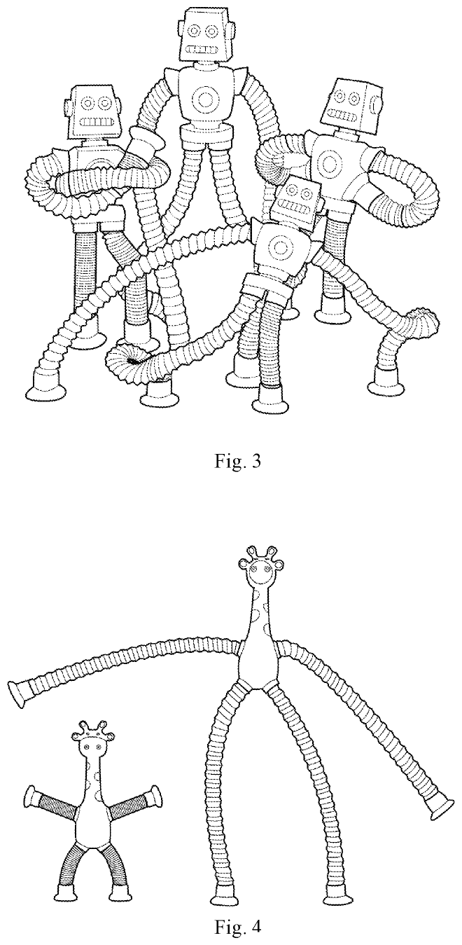

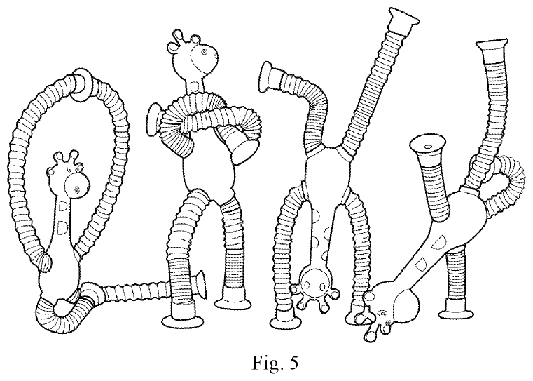

The apparatus and method components have been represented where appropriate by conventional symbols in the drawings, showing only those specific details

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides a novel suction fidget tubes travel toy comprises 4 individually packaged toy characters meticulously engineered to ensure a robust and secure suction fidget tubes interaction. Crafted in vibrant opaque colors, these toy characters are specifically designed to offer a captivating and enduring play experience, making them ideal companions for travel scenarios. With their superior suction fidget tubes properties and durable construction, these toys guarantee hours of entertainment for children while ensuring safety and reliability throughout extended use.

As per preferred embodiments of the invention, the suction fidget tubes travel toy represents a breakthrough in suction fidget tubes toy design, featuring a flexible and stretchable composition that unlocks a myriad of creative possibilities for play. Its innovative design allows for seamless manipulation, enabling children to explore various poses, scenarios, and interactive activities with ease. Moreover, the toy's advanced suction technology ensures unparalleled strength and stability, surpassing industry standards for suction fidget tubes toy safety and longevity.

As per preferred embodiments of the invention, the proposed toy's distinguishing features is its versatility, catering to a wide range of play environments beyond travel settings. Whether utilized during church services, school activities, or leisure time at home, this suction fidget tubes toy remains engaging and captivating for children of all ages. Its adaptability ensures sustained entertainment and engagement across diverse scenarios, enhancing the overall play experience for young users.

As per preferred embodiments of the invention, the proposed toy serves as a valuable tool for individuals with attention deficits, particularly through its anxiety-relieving variant. Recognized for its therapeutic potential, this suction fidget tubes toy has gained popularity among educators and caregivers in special education settings. By offering a calming and soothing tactile experience, the proposed toy facilitates stress relief and focus improvement, contributing to enhanced cognitive functioning and emotional well-being.

As per preferred embodiments of the invention, the proposed toy exemplifies a commitment to social responsibility by supporting community initiatives aimed at addressing the needs of individuals with anxiety and ADHD. Through strategic donations and partnerships, the proposed toy ensures that these therapeutic toys are accessible to those who can benefit most from their therapeutic properties. This philanthropic endeavor underscores the toy's dedication to making a positive impact on society by promoting inclusivity, accessibility, and well-being through innovative play solutions.

As per preferred embodiments of the invention, the proposed suction fidget tubes travel toy epitomizes the convergence of advanced engineering, versatility, and social responsibility in the realm of suction fidget tubes toys. By offering a seamless blend of entertainment, education, and therapeutic benefits, the toy enriches the lives of children and individuals with attention deficits while advancing the boundaries of suction fidget tubes toy design and functionality.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A suction fidget tubes travel toy comprising four individually packaged toy characters, each featuring a robust and secure suction fidget tubes interaction mechanism for enhanced playability.

2. The suction fidget tubes travel toy of claim 1, wherein the toy characters are meticulously crafted with durable materials to ensure longevity and withstand prolonged use.

3. The suction fidget tubes travel toy of claim 1, wherein an innovative flexible and stretchable design integrated into each toy character, enabling seamless manipulation and fostering imaginative play scenarios.

4. The suction fidget tubes travel toy of claim 1, wherein the flexible design allows children to explore various poses, scenarios, and interactive activities with ease and creativity.

5. The suction fidget tubes travel toy of claim 1, wherein an advanced flexible tube and suction cup design within each toy character, providing exceptional strength and stability in suction fidget tubes interactions, surpassing industry safety standards.

6. The suction fidget tubes travel toy of claim 1, wherein the advanced suction fidget tubes technology ensures reliable and secure connections, enhancing the overall play experience.

7. The suction fidget tubes travel toy of claim 1, wherein versatility in the application of the suction fidget tubes travel toy, suitable for diverse play environments including travel, home leisure, church services, and school activities.

8. The suction fidget tubes travel toy of claim 1, wherein an anxiety-relieving variant of the suction fidget tubes travel toy designed to provide therapeutic benefits for individuals with attention deficits, anxiety, and ADHD.

9. The suction fidget tubes travel toy of claim 1, wherein the anxiety-relieving variant offers a calming and soothing tactile experience, promoting stress relief and focus improvement.

10. The suction fidget tubes travel toy of claim 1, wherein the suction cup at the bottom allows it to be attached to smooth surfaces like mirrors, windows, and tiles.
